(19) United States
(12) Patent Application Publication
(10) Pub. No.: US 2026/0261426 A1
(43) Pub. Date: Sep. 3, 2026

(54) TARGET HASH PROOF OF WORK SYSTEM WITH DEVICE DETECTION

(71) Applicant: Arkose Labs Holdings, Inc., San Mateo, CA (US)

(72) Inventors: Luke Stork, San Mateo, CA (US); Mitchell Davies, San Mateo, CA (US); Aniket Gangadharan Nambiar, San Mateo, CA (US)

(21) Appl. No.: 19/067,116

(22) Filed: Feb. 28, 2025

(51) Int. Cl. H04L 9/32; H04L 9/40

(52) U.S. Cl. CPC H04L 9/3239; H04L 9/3271; H04L 63/14

(57) ABSTRACT

A system and method of detecting attackers in a computing environment. The method includes receiving a request to authenticate a user of a client device that is requesting access to a webpage. The method includes determining a computational ability of the client device based on a device profile associated with the client device. The method includes generating a proof of work (PoW) challenge based on the computational ability of the client device. The method includes acquiring an input dataset corresponding to one or more attempts by the user of the client device to solve the PoW challenge. The method includes generating, based on the input dataset, a report indicating whether the user of the client device is a human user or a bot user.

### TECHNICAL FIELD

The present disclosure relates generally to cybersecurity, and more particularly, to a target hash proof of work system that detects attackers in a computing environment by adjusting the difficult levels of proof of work challenges for client devices based on the computational capabilities of the client devices.

### BACKGROUND

Cybersecurity is the practice of protecting critical systems and sensitive information from digital attacks. Cybersecurity techniques are designed to combat threats against networked systems and applications, whether those threats originate from inside or outside of an organization. AI can significantly enhance cybersecurity by automating threat detection, analyzing vast amounts of data for patterns indicative of cyber threats, and responding to incidents in real-time.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for detecting attackers in a computing environment by adjusting the difficult levels of proof of work challenges for client devices based on the computational capabilities of the client devices;

FIG. 2 is a flow diagram depicting a method of detecting attackers in a computing environment, according to some embodiments;

FIG. 3 is a flow diagram depicting a method of detecting attackers in a computing environment, according to some embodiments;

FIG. 4 is a flow diagram depicting a method of estimating a client device’s computational abilities based on a machine learning approach, according to some embodiments;

FIG. 5A is a block diagram depicting an example of the THPD system in FIG. 1, according to some embodiments;

FIG. 5B is a block diagram depicting an example of the host machine of the environment in FIG. 1, according to some embodiments;

FIG. 6 is a flow diagram depicting a method of detecting attackers in a computing environment by adjusting the difficult levels of proof of work challenges for client devices based on computational capabilities of the client devices; and

FIG. 7 is a block diagram of an example computing device that may perform one or more of the operations described herein, in accordance with some embodiments.

### DETAILED DESCRIPTION

Proof of work (PoW) technology may be used to detect and mitigate automated traffic across the internet and is also integral to cryptocurrency mining. A key characteristic of PoW schemes is their asymmetry: the computational task must be moderately difficult and resource-intensive for the client device, ensuring they expend significant effort. However, verification of the solution is designed to be quick and straightforward for the service provider, allowing for efficient validation. This asymmetry creates a barrier for potential attackers, as it becomes impractical for them to carry out large-scale automated attacks.

The PoW challenge involves solving a complex mathematical or cryptographic puzzle through brute force. For example, one common puzzle requires calculating a hash value with a specific number of leading zeros, based on a given seed and difficulty level. When applied in the context of bot detection and mitigation, this minute amount of work demanded from the client device can become computationally prohibitive for malicious actors that attempt to access web resources or endpoints in parallel at very high request rates.

However, the conventional system never considers whether a client device has sufficient computational resources (e.g., processing power, memory) to solve a PoW challenge before sending the PoW challenge to the client device. Consequently, this can lead to inefficiencies and potential service disruptions, as trustworthy client devices with limited computational resources may struggle to complete the PoW challenge, resulting in delays or failed attempts to access the protected resource. This oversight can particularly affect older or less powerful devices, exacerbating the user experience and potentially excluding a segment of legitimate users from accessing services. Thus, there is a long-felt, unsolved need for an advanced detection method that accounts for the varying computational abilities of client device to detect malicious attacks against a computing environment.

The approaches disclosed herein differ from prior work in that it allows for more precise control of client-side PoW execution times by using a target hash challenge approach combined with a statistically derived method of device benchmarking to predetermine a device’s computational ability before serving the challenge to the client device.

Aspects of the present disclosure address the above-noted and other deficiencies by providing a target hash proof of work (THPD) system that dynamically adjusts the difficulty of a PoW challenge (which includes a set of computational tasks) to be solved by a particular client device based on the client device’s computational ability (e.g., hash rate) and the target execution time (e.g., difficulty) of the PoW challenge. The PoW challenge involves performing hash computations, which the THPD expects the client device to complete within a defined target time. The PoW challenge is split into multiple parts (sometimes referred to herein as splits) to add complexity and prevent potential exploits such as precomputing the challenge from higher numbers. The validation process ensures that each split is solved correctly and that the entire PoW is validated in parts before confirming the overall success.

The present embodiments differ from the conventional system in several ways including, for example, by allowing for more precise control of client-side PoW execution times by using a target hash challenge approach. This is combined with a statistically derived method of device benchmarking to predetermine a device’s computational ability before serving the PoW challenge.

In an illustrative embodiment, a target hash proof of work (THPD) system receives a request to authenticate a user of a client device that is requesting access to a webpage. The THPD system receives a request to authenticate a user of a client device that is requesting access to a webpage. The THPD system determines a computational ability of the client device based on a device profile associated with the client device. The THPD system generates a proof of work (PoW) challenge based on the computational ability of the client device. The THPD system acquires an input dataset corresponding to one or more attempts by the user of the client device to solve the PoW challenge. The THPD system generates, based on the input dataset, a report indicating whether the user of the client device is a human user or a bot user.

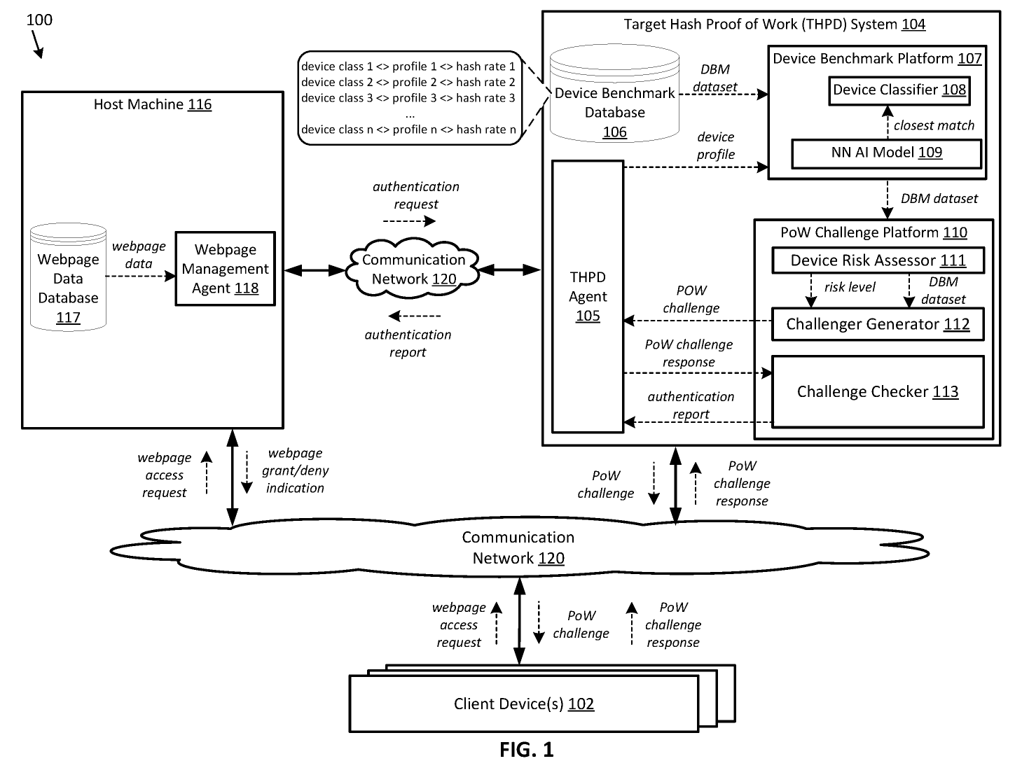

FIG. 1 is a block diagram depicting an example environment for detecting attackers in a computing environment by adjusting the difficult levels of proof of work challenges for client devices based on the computational capabilities of the client devices, according to some embodiments. The environment 100 includes a target hash proof of work (THPD) system 104, one or more client devices 102, and a host machine 116 that are each communicably coupled together via a communication network 120. The THPD system 104 includes and/or executes a THPD agent 105, a device benchmark platform 107, and a PoW challenge platform 110.

The PoW challenge platform 110 includes a device risk assessor 111 configured to determine a risk level (threat level) associated with a client device 102. The PoW challenge platform includes a challenge generator 112 configured to generate a PoW challenge based on the risk level and/or a computational ability of the client device 102. The PoW challenge platform includes a challenge checker 113 configured to analyze one or more answers that the client device 102 generated to solve the PoW challenge to determine whether one or more answers are correct, answered in the correct sequence, and/or answered within a particular time frame.

The device benchmark platform 107 includes a device classifier 108 and a near-neighbor (NN) artificial intelligence (AI) model 109. The device classifier 108 is configured to determine a device class for a client device 102. Specifically, the THPD system 104 determines that it has previously processed information for the device class of a particular client device 102 before because it determined that there is an exact match when using the device profile of the particular client device 102 to search the device benchmark database 106.

However, if there is not an exact match, then the THPD system can use its near-neighbor (NN) artificial intelligence (AI) model 109. The THPD agent 105 trains, using a set of training data from the device benchmark database 106, the NN AI model 109 to identify a closest matching device classification for a client device 102 based on the device profile of the client device, and generate an output indicating the closest matching device classification. As discussed here, the THPD agent 105 then provides the closest matching device classification to the device classifier 108, which in turn, searches the device benchmark database 106 for an exact match to the closest matching device classification of the client device 102.

The THPD system 104 includes a device benchmark database 106 that is configured to store a mapping between a plurality of device classes, a plurality of device profiles, and a plurality of hash rates, where each device class is respectively associated with a device profile and a hash rate. For example, as shown in FIG. 1, device class 1 is mapped to device profile 1 and hash rate 1, device class 2 is mapped to device profile 2 and hash rate 2, device class 3 is mapped to device profile 3 and hash rate 3, and so on. A device profile for a client device 102 that is mapped to a particular device class may indicate an operating system, a number of available processing cores, graphics rendering capabilities, browser information (e.g., version, brand), and/or a web graphics library. A hash rate (sometimes referred to as benchmark hash rate) for a client device 102 that is mapped to a particular device class may indicate the client device’s 102 computational speed in terms of hash calculations per second. This hash rate is derived experimentally using production data along with statistics and machine learning. As discussed herein, the THPD system 104 uses the hash rate to adjust the difficulty of the challenge (PoW challenge) sent to the client device 102.

The host machine 116 includes and/or executes a webpage management agent 118 that hosts one or more webpages that are locally stored in its webpage data database 117.

The communication network 120 may be a public network (e.g., the internet), a private network (e.g., a local area network (LAN) or wide area network (WAN)), or a combination thereof. In one embodiment, communication network 120 may include a wired or a wireless infrastructure, which may be provided by one or more wireless communications systems, such as wireless fidelity (Wi-Fi) connectivity to the communication network 120 and/or a wireless carrier system that can be implemented using various data processing equipment, communication towers (e.g., cell towers), etc. The communication network 120 may carry communications (e.g., data, message, packets, frames, etc.) between any other the computing device.

The THPD system 104, host machine 116, and client device 102 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

Still referring to FIG. 1, the host machine 116 receives, from the client device 102, a webpage access request to access a webpage that is hosted by the host machine 116. The request includes a device profile associated with the client device 102. The device benchmark platform 107 determines a computational ability of the client device 102 based on the device profile associated with the client device 102. The PoW challenge platform 110 generates a PoW challenge based on the computational ability of the client device 102. The THPD agent 105 sends the PoW challenge to the client device 102. In response the THPD agent 105 receives a response (shown in FIG. 1 as PoW challenge response) from the client device 102, wherein the response includes an input dataset (e.g., one or more answers) corresponding to one or more attempts by the user of the client device to solve the PoW challenge. The PoW challenge platform 110 generates, based on the input dataset, a report (shown in FIG. 1 as authentication report) indicating whether the user of the client device 102 is a human user or a bot user. The THPD agent 105 sends the report to the host machine 116.

The host machine 116 can decide, based on the authentication report, whether to grant the client device 102 access to the requested webpage or deny the client device 102 from accessing the webpage. If the host machine 116 grants access, then the host machine 116 send the webpage to the client device 102. However, if the host machine denies access, then the host machine 116 does not send the webpage to the client device 102, and instead sends an indication to the client device 102 indicating that the client device 102 does not have permission to access the webpage.

Although FIG. 1 shows only a select number of computing devices (e.g., THPD system 104, host machine 116, and client devices 102), the environment 100 may include any number of computing devices that are interconnected in any arrangement to facilitate the exchange of data between the computing devices.

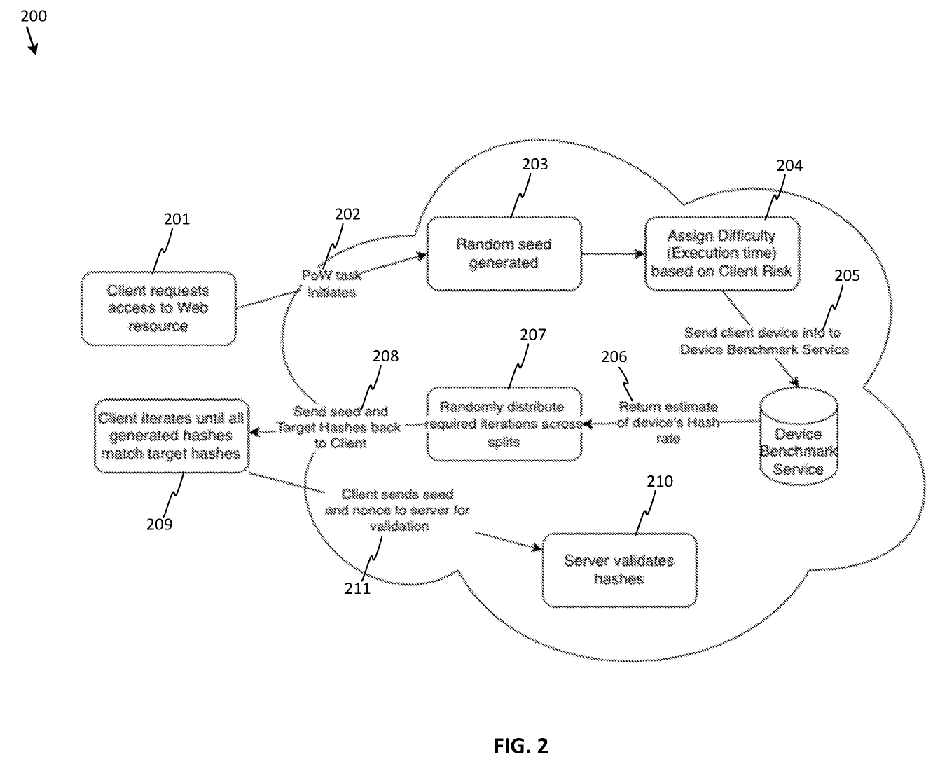

FIG. 2 is a flow diagram depicting a method of detecting attackers in a computing environment, according to some embodiments. Method 200, which includes blocks 201-211, may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 200 may be performed by one or more target hash proof of work system, such as THPD system 104 in FIG. 1.

A target time may refer to how long the client device 102 has to complete the PoW challenge. By setting the target time (e.g., 5 seconds), the THPD system 104 can dynamically scale the difficulty of the PoW challenge to match the risk of the client device 102. High risk client device should perform more work than client devices deemed to be lower risk. The target time impacts the overall computational work demanded to complete the PoW challenge, directly influencing the number of hash operations performed.

A hash rate represents the client device’s 102 computational speed in terms of hash calculations per second. This hash rate is derived experimentally using production data along with statistics and machine learning and is further described herein with respect to the Device Benchmarking. For example, a statistically derived benchmark hash rate for a client device 102 may be 1000 hashes per second. The THPD system 104 may use this benchmark hash rate to adjust the difficulty of the PoW challenge sent to the client device 102.

Still referring to FIG. 2, The THPD system 104 calculates a difficulty for the PoW challenge by multiplying the target time by the client device’s 102 hash rate. This yields the number of hash operations the client device 102 is to perform when attempting to solve the PoW challenge and, upon submission and validation, proceed to the endpoint. For example, if the target client side execution time is 5 seconds and the hash rate is 1000 hashes per second, the PoW challenge instructs the client device 102 to perform 5000 hashes to calculate the correct answer to the PoW challenge. This work will be securely validated on the THPD system 104 once complete.

The THPD system 104 splits (e.g., divides) the work associated with solving a PoW challenge into multiple splits, where each split has its own difficulty and target hash. The purpose of splitting the PoW into separate parts is to prevent attacks where the client device 102 might attempt to bypass the PoW challenge by starting from higher nonces or using pre-computed values. By splitting the work (1) malicious actors are forced to solve each split correctly, and failure to solve one of the splits means the overall challenge fails; and (2) malicious actors are forced to solve each split in sequence, making it harder for the malicious actor to use parallel processing or shortcut methods like starting from a higher iteration count.

The THPD system 104 generates an authentication report indicating that the client device 102 should be granted access to the web resource if the client device 102 successfully completes all iterations of the PoW challenge.

### Challenge Generation Process

The THPD system 104 generates a seed and then uses the seed to derive a target hash for each split. The target hash is a unique value and contains a PoW token. The THPD system 104 stores the target hash in the device benchmark database 106, and later uses the stored target hash for the verification process (and to avoid precomputing the result).

The THPD system 104 distributes the total target time (e.g., 5 seconds) across the multiple splits using random weights, making each split have a different difficulty, therefore associated with different amounts of hashes. The THPD system 104 can use any number of splits, and the higher the number of splits, the greater the difficulty to reliably pre-compute a response.

The THPD system 104 calculates the difficulty (e.g., hash iterations) for each split based on the split target times and the hash rate, which is derived from the device benchmark system.

### Challenge Solve Process

The client device 102 obtains (e.g., retrieves or receives) the PoW challenge from the THPD system 104 and attempts to solve each split sequentially. In some embodiments, the plurality of splits of the PoW challenge include, and are respectively associated with, a plurality of sequence identifiers (e.g., 1, 2, 3) indicating the sequence in which the client device 102 should solve each of the splits. The client device 102 starts with the provided starting nonce and computes hashes iteratively. For each split, the client computes the hash by combining the seed and the current nonce and compares the result with the target hash provided by the THPD system 104. Once all splits are solved (i.e., the hashes match), the client device 102 sends the results to the THPD system 104 for validation. That is, the THPD system 104 determines whether the results correctly solve each of the splits within an expected amount of time and in the correct sequential order.

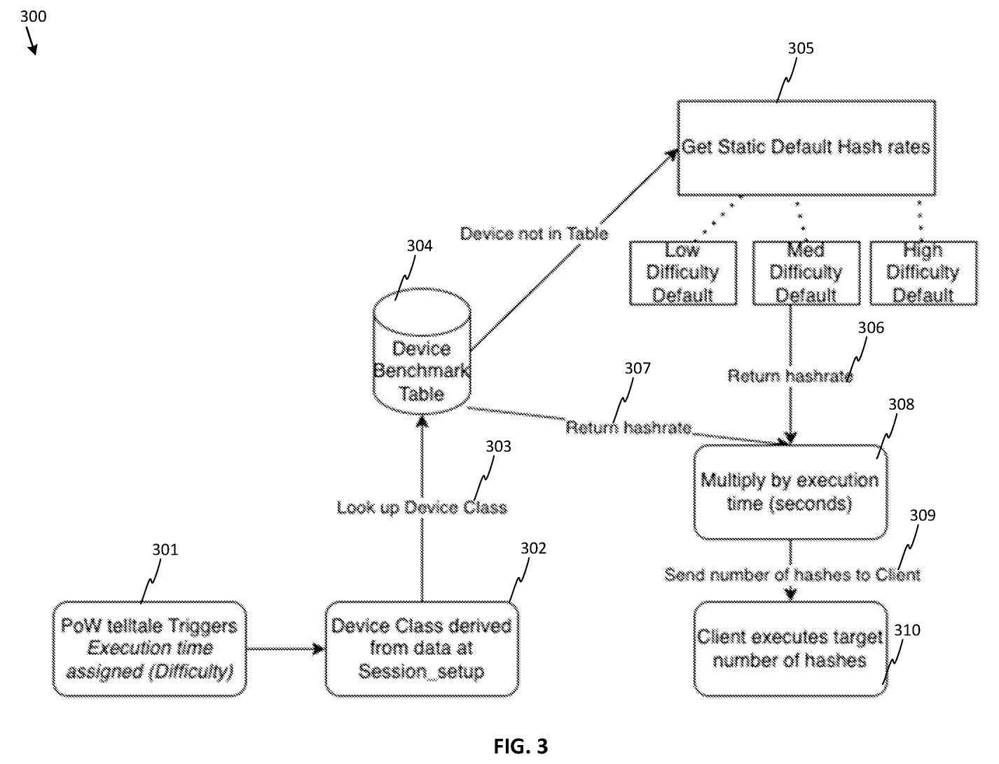

FIG. 3 is a flow diagram depicting a method of detecting attackers in a computing environment, according to some embodiments. Method 300, which includes blocks 301-310, may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 300 may be performed by one or more target hash proof of work system, such as THPD system 104 in FIG. 1

Still referring to FIG. 3, the THPD system 104 has the ability to accurately estimate the computational abilities of a client device 102 using information (e.g., device profile) available within a web browser or native application. By accurately estimating an incoming device’s computational abilities, measured in hashes per second, the THPD system 104 can determine a predictable PoW execution time on the client device 102 regardless if the client device 102 is a mobile phone, desktop computer, or other IoT (Internet of Things) device. The desired execution time of the PoW task can simply be multiplied by the estimate of the client device’s 102 hash rate to determine the number of PoW hashes to be split randomly and run on the client device 102.

To determine the computational abilities of devices, large amounts of production data were collected in a benchmark proof of work challenge. This benchmark PoW challenge instructs the client device 102 to solve a simple implementation of the common “leading 0’s” PoW challenge. The client device’s 102 hash rate was logged during this PoW task along with Javascript® data that identifies the operating system, number of Central Processing Unit (CPU) cores available, and information pertaining to the graphics rendering capabilities of the device. For example, 10’s of millions of independent client PoW solutions were logged to build this raw dataset.

A device class was derived from this data based on the most relevant information related to a client device’s 102 computational abilities. An example of one device class may be as follows:

iOS - 18.0.1 - 8 - Mobile Safari - Apple GPU.

Using statistics, outliers were removed, and estimates of the client device 102’s hash rate were stored in the device benchmark database 106 (e.g., device benchmark table 304 in FIG. 3). Two approaches of leveraging this raw device benchmarking data were used to estimate the computational capabilities of future interactions.

Thus, FIG. 3 shows how the device benchmark system is leveraged to return estimates of a client device’s 102 computational ability. In this embodiment, if the THPD system 104 has not previously seen a particular client device 102, then the THPD system 104 can use statistically derived defaults in place of estimates based on production data.

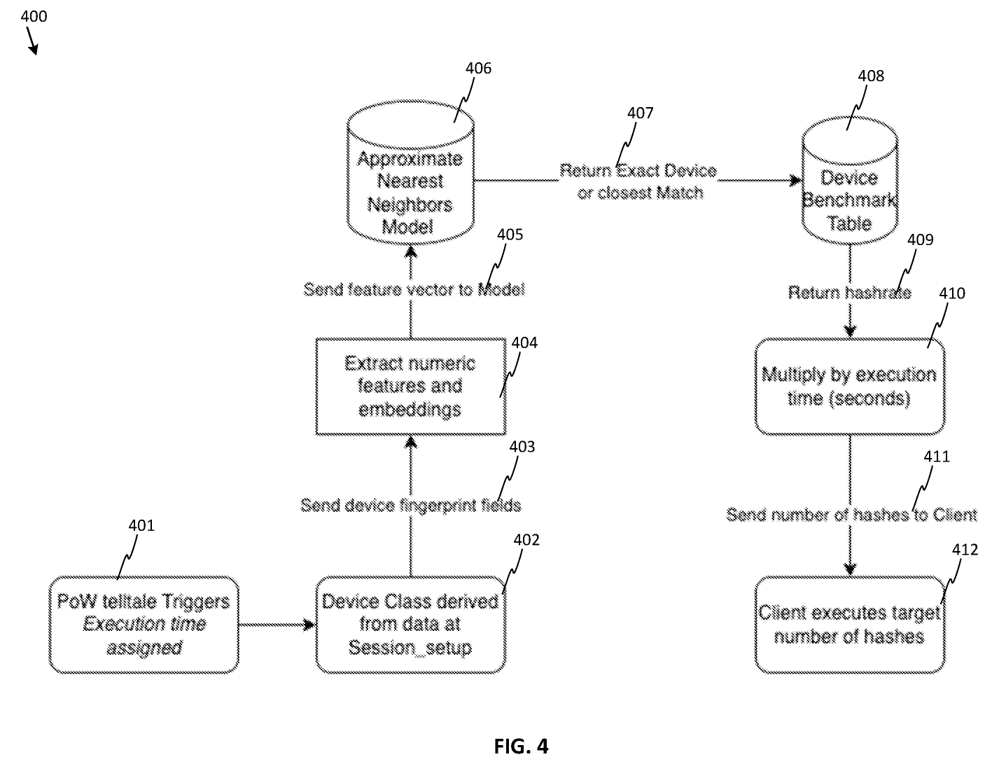

FIG. 4 is a flow diagram depicting a method of estimating a client device’s computational abilities based on a machine learning approach, according to some embodiments. Method 400, which includes blocks 401-412, may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 400 may be performed by one or more target hash proof of work system, such as THPD system 104 in FIG. 1.

Specifically, FIG. 4 shows how the THPD system 104 can use a machine learning approach to estimate a client device’s 102 computational abilities even if it is a never before seen device, based on the past results of millions of production samples.

To provide an estimate of a client device’s 102 hash rate, the THPD system 104 extracts a set of features from the device class and generates a numerical vector based on these extracted features. These features include, for example, operating system name and versions, count of CPU cores, and vector embeddings that are computed from the browser name, and web graphics renderers. The THPD system 104 uses these features to train an approximate nearest neighbors model (e.g., NN AI model 109, approximate nearest neighbors model) that returns the closest match of a device class. If a new device has not been seen before, the closest match of a client device 102 can be returned from the model and the THPD system 104 uses its computational estimates to return a PoW task of appropriate difficulty. For example, a newly released smartphone might not have any historic data associated with it. Therefore, the THPD system 104 would use this machine learning approach to compute numeric features from the device profile in the browsing session and return the latest smartphone model that closely matches the incoming client device 102. The THPD system 104 would then use the computational abilities of this latest smartphone model to generate and serve a PoW challenge of appropriate difficulty to the client device 102.

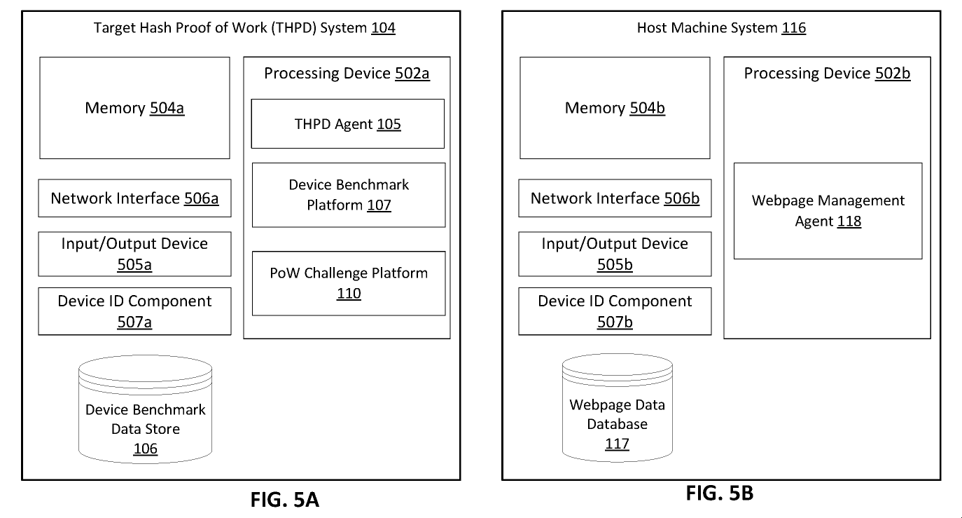

FIG. 5A is a block diagram depicting an example of the THPD system in FIG. 1, according to some embodiments. While various devices, interfaces, and logic with particular functionality are shown, it should be understood that the THPD system 104 includes any number of devices and/or components, interfaces, and logic for facilitating the functions described herein. For example, the activities of multiple devices may be combined as a single device and implemented on a same processing device (e.g., processing device 502a), as additional devices and/or components with additional functionality are included.

The THPD system 104 includes a processing device 502a (e.g., general purpose processor, a PLD, etc.), which may be composed of one or more processors, and a memory 504a (e.g., synchronous dynamic random-access memory (DRAM), read-only memory (ROM)), which may communicate with each other via a bus (not shown).

The processing device 502a may be provided by one or more general-purpose processing devices such as a microprocessor, central processing unit, or the like. In some embodiments, processing device 502a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 502a may include one or more special-purpose processing devices such as an application specific integrated circuit (ASIC), a field programmable gate array (FPGA), a digital signal processor (DSP), network processor, or the like. The processing device 502a may be configured to execute the operations described herein, in accordance with one or more aspects of the present disclosure, for performing the operations and steps discussed herein.

The memory 504a (e.g., Random Access Memory (RAM), Read-Only Memory (ROM), Non-volatile RAM (NVRAM), Flash Memory, hard disk storage, optical media, etc.) of processing device 502a stores data and/or computer instructions/code for facilitating at least some of the various processes described herein. The memory 504a includes tangible, non-transient volatile memory, or non-volatile memory. The memory 504a stores programming logic (e.g., instructions/code) that, when executed by the processing device 502a, controls the operations of the THPD system 104. In some embodiments, the processing device 502a and the memory 504a form various processing devices and/or circuits described with respect to the THPD system 104. The instructions include code from any suitable computer programming language such as, but not limited to, C, C++, C#, Java, JavaScript, VBScript, Perl, HTML, XML, Python, TCL, and Basic.

The processing device 502a executes the THPD agent 105, the device benchmark platform 107, and the PoW challenge platform 110. The THPD agent 105 includes the device benchmark database 106.

The THPD agent 105 receives a request to authenticate a user of a client device 102 that is requesting access to a webpage. The THPD agent 105 uses the device benchmark platform 107 to determine a computational ability of the client device 102 based on a device profile associated with the client device 102. The THPD agent 105 uses the PoW challenge platform 110 to generate a PoW challenge based on the computational ability of the client device 102. The THPD agent 105 acquires an input dataset corresponding to one or more attempts by the user of the client device 102 to solve the PoW challenge. For example, the input dataset is included in a PoW challenge response that the client device 102 sends to the THPD system 104 responsive to attempting to solve the PoW challenge. The THPD agent 105 uses the PoW challenge platform 110 to generate, based on the input dataset, a report indicating whether the user of the client device 102 is a human user or a bot user.

In some embodiments, the device profile associated with the client device 102 indicates at least one of an operating system, a number of available processing cores, or graphics rendering capabilities.

The THPD agent 105 may determine the computational ability of the client device 102 by maintaining a database (e.g., device benchmark database 106) that includes a plurality of mappings between a plurality of device classifications, a plurality of device profiles, and a plurality of hash rates. The THPD agent 105 may further determine a classification for the client device 102 by comparing the device profile of the client device 102 to the database.

The THPD agent 105 may determine the classification for the client device 102 by determining an absence of an entry in the database corresponding to the device profile of the client device 102. The THPD agent 105 may further provide, responsive to determining the absence of the entry in the database, the device profile to a near-neighbor model (e.g., NN AI model 109) trained to identify a closest matching classification for the client device 102 based on the device profile. The THPD agent 105 may further generate, based on the device profile and the near-neighbor model, a model output indicating the closest matching classification for the client device 102. For example, the NN AI model 109 may identify the closest match to the client device 102 by calculating distance metrics from the client device 102 (as represented by the device profile) to each device class in the device benchmark database 106 and selecting the device class corresponding to the shortest distance. The THPD agent 105 then determines a matching classification for the client device 102 by comparing the closest matching classification for the client device to the device benchmark database 106.

The THPD agent 105 may generate the PoW challenge based on the computational ability of the client device by determining a threat level (e.g., risk level) associated with the client device 102 based on the classification; and defining a difficulty level for the PoW challenge by adjusting, based on the threat level, a target time associated with completing the PoW challenge.

The THPD agent 105 may generate the PoW challenge based on the computational ability of the client device 102 by splitting the PoW challenge into a plurality of parts that are respectively associated with a plurality of sequence identifiers; providing the plurality of parts to the client device 102; and extracting, from the input dataset, a plurality of answers respectively associated with the plurality of parts responsive to providing the plurality of parts to the client device 102.

The THPD agent 105 may generate a random number and split the PoW challenge into the plurality of parts based on the randomly generated number.

The THPD agent 105 may determine a plurality of solutions to the plurality of parts; and verify that each of the plurality of answers match the plurality of solutions.

The THPD agent 105 may determine, from the PoW challenge response, a sequence in which the client device 102 generated the plurality of answers. The THPD agent 105 may determine whether the sequence satisfies a sequential ordering indicated by the plurality of sequence identifiers, and either indicate in the report that the client device 102 is the bot user responsive to determining that the sequence does not satisfy the sequential ordering indicated by the plurality of sequence identifiers, or indicate in the report that the client device 102 is the human user responsive to determining that the sequence satisfies the sequential ordering indicated by the plurality of sequence identifiers.

The THPD agent 105 may determine, based on the input dataset, a total execution time for the client device 102 to solve the PoW challenge. The THPD agent 105 may determine, based on the classification for the client device 102, an expected execution time for the client device 102 to solve the PoW challenge. The THPD agent 105 may determine whether the expected execution time exceeds the total execution time, and either indicate in the report that the client device 102 is the bot user responsive to determining that the expected execution time exceeds the total execution time, or indicate in the report that the client device 102 is the human user responsive to determining that the expected execution time does not exceed the total execution time.

The THPD system 104 includes a network interface 506a configured to establish a communication session with a computing device for sending and receiving data over the communication network 120 to the computing device. Accordingly, the network interface 506a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the THPD system 104 includes a plurality of network interfaces 506a of different types, allowing for connections to a variety of networks, such as local area networks (public or private) or wide area networks including the Internet, via different sub-networks.

The THPD system 104 includes an input/output device 505a configured to receive user input from and provide information to a user. In this regard, the input/output device 505a is structured to exchange data, communications, instructions, etc. with an input/output component of the THPD system 104. Accordingly, input/output device 505a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the THPD system 104, such as a built-in display, touch screen, microphone, etc., or external to the housing of THPD system 104, such as a monitor connected to THPD system 104, a speaker connected to THPD system 104, etc., according to various embodiments. In some embodiments, the THPD system 104 includes communication circuitry for facilitating the exchange of data, values, messages, and the like between the input/output device 505a and the components of the THPD system 104. In some embodiments, the input/output device 505a includes machine-readable media for facilitating the exchange of information between the input/output device 505a and the components of the THPD system 104. In still another embodiment, the input/output device 505a includes any combination of hardware components (e.g., a touchscreen), communication circuitry, and machine-readable media.

The THPD system 104 includes a device identification component 507a (shown in FIG. 5A as device ID component 507a) configured to generate and/or manage a device identifier associated with the THPD system 104. The device identifier may include any type and form of identification used to distinguish the THPD system 104 from other computing devices. In some embodiments, to preserve privacy, the device identifier may be cryptographically generated, encrypted, or otherwise obfuscated by any device and/or component of THPD system 104. In some embodiments, the THPD system 104 may include the device identifier in any communication (e.g., PoW challenge, authentication report, etc.) that the THPD system 104 sends to a computing device.

The THPD system 104 includes a bus (not shown), such as an address/data bus or other communication mechanism for communicating information, which interconnects the devices and/or components of THPD system 104, such as processing device 502a, network interface 506a, input/output device 505a, and device ID component 507a.

In some embodiments, some or all of the devices and/or components of THPD system 104 may be implemented with the processing device 502a. For example, the THPD system 104 may be implemented as a software application stored within the memory 504a and executed by the processing device 502a. Accordingly, such embodiment can be implemented with minimal or no additional hardware costs. In some embodiments, any of these above-recited devices and/or components rely on dedicated hardware specifically configured for performing operations of the devices and/or components.

FIG. 5B is a block diagram depicting an example of the host machine of the environment in FIG. 1, according to some embodiments. While various devices, interfaces, and logic with particular functionality are shown, it should be understood that the client device 102 includes any number of devices and/or components, interfaces, and logic for facilitating the functions described herein. For example, the activities of multiple devices may be combined as a single device and implemented on a same processing device (e.g., processing device 502b), as additional devices and/or components with additional functionality are included.

The host machine 116 includes a processing device 502b (e.g., general purpose processor, a PLD, etc.), which may be composed of one or more processors, and a memory 504b (e.g., synchronous dynamic random-access memory (DRAM), read-only memory (ROM)), which may communicate with each other via a bus (not shown). The processing device 502b includes identical or nearly identical functionality as processing device 502a in FIG. 5a, but with respect to devices and/or components of the host machine 116 instead of devices and/or components of the THPD system 104.

The memory 504b of processing device 502b stores data and/or computer instructions/code for facilitating at least some of the various processes described herein. The memory 504b includes identical or nearly identical functionality as memory 504a in FIG. 5A, but with respect to devices and/or components of the host machine 116 instead of devices and/or components of the THPD system 104.

The processing device 502b may be configured to execute a webpage management agent 118 that is configured to receive a request from a client device 102 to access a webpage that is hosted by the host machine 116. The webpage management agent 118 may be configured to send, to the THPD system 104, a request to authenticate a user of the client device 102 in response to receiving the request from the client device 102 to access the webpage. The webpage management agent 118 may be configured to receive messages from the THPD system 104. If the message indicates that the user of the client device 102 is a bot and/or should be denied access to the webpage, then the webpage management agent 118 may decide to deny the client device 102 the ability to access the webpage. Alternatively, if the message indicates that the user of the client device 102 is a human user and/or should be allowed access to the webpage, then the webpage management agent 118 may decide to allow the client device 102 the ability to access the webpage by sending the webpage to the client device 102.

The host machine 116 includes a network interface 506b configured to establish a communication session with a computing device for sending and receiving data over a network to the computing device. Accordingly, the network interface 506b includes identical or nearly identical functionality as network interface 506a in FIG. 5A, but with respect to devices and/or components of the host machine 116 instead of devices and/or components of the THPD system 104.

The host machine 116 includes an input/output device 505b configured to receive user input from and provide information to a user. In this regard, the input/output device 505b is structured to exchange data, communications, instructions, etc. with an input/output component of the host machine 116. The input/output device 505b includes identical or nearly identical functionality as input/output device 505a in FIG. 5A, but with respect to devices and/or components of the host machine 116 instead of devices and/or components of the THPD system 104.

The host machine 116 includes a device identification component 507b (shown in FIG. 5B as device ID component 507b) configured to generate and/or manage a device identifier associated with the host machine 116. The device ID component 507b includes identical or nearly identical functionality as device ID component 507a in FIG. 5A, but with respect to devices and/or components of the host machine 116 instead of devices and/or components of the THPD system 104.

The host machine 116 includes a bus (not shown), such as an address/data bus or other communication mechanism for communicating information, which interconnects the devices and/or components of the host machine 116, such as processing device 502b, network interface 506b, input/output device 505b, and device ID component 507b.

In some embodiments, some or all of the devices and/or components of host machine 116 may be implemented with the processing device 502b. For example, the host machine 116 may be implemented as a software application stored within the memory 504b and executed by the processing device 502b. Accordingly, such embodiment can be implemented with minimal or no additional hardware costs. In some embodiments, any of these above-recited devices and/or components rely on dedicated hardware specifically configured for performing operations of the devices and/or components.

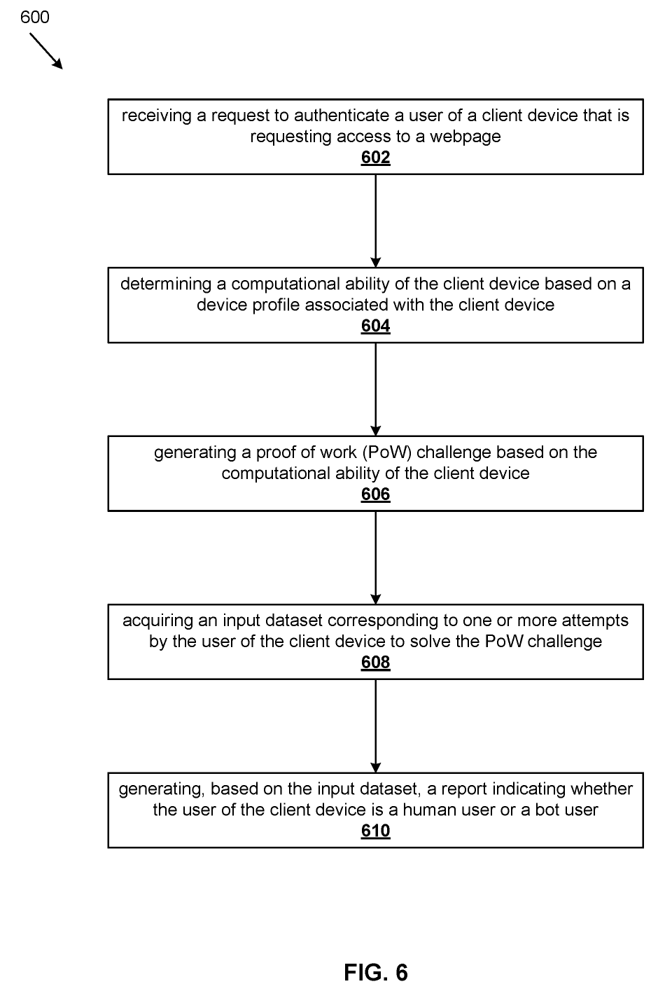

FIG. 6 is a flow diagram depicting a method of detecting attackers in a computing environment by adjusting the difficult levels of proof of work challenges for client devices based on computational capabilities of the client devices, according to some embodiments. Method 600 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 600 may be performed by one or more target hash proof of work system, such as THPD system 104 in FIG. 1.

With reference to FIG. 6, method 600 illustrates example functions used by various embodiments. Although specific function blocks ("blocks") are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed.

As shown in FIG. 6, the method 600 includes the block 602 of receiving a request to authenticate a user of a client device that is requesting access to a webpage. The method 600 includes the block 604 of determining a computational ability of the client device based on a device profile associated with the client device. The method 600 includes the block 606 of generating a PoW challenge based on the computational ability of the client device. The method 600 includes the block 608 of acquiring an input dataset corresponding to one or more attempts by the user of the client device to solve the PoW challenge. The method 600 includes the block 610 of generating, based on the input dataset, a report indicating whether the user of the client device is a human user or a bot user.

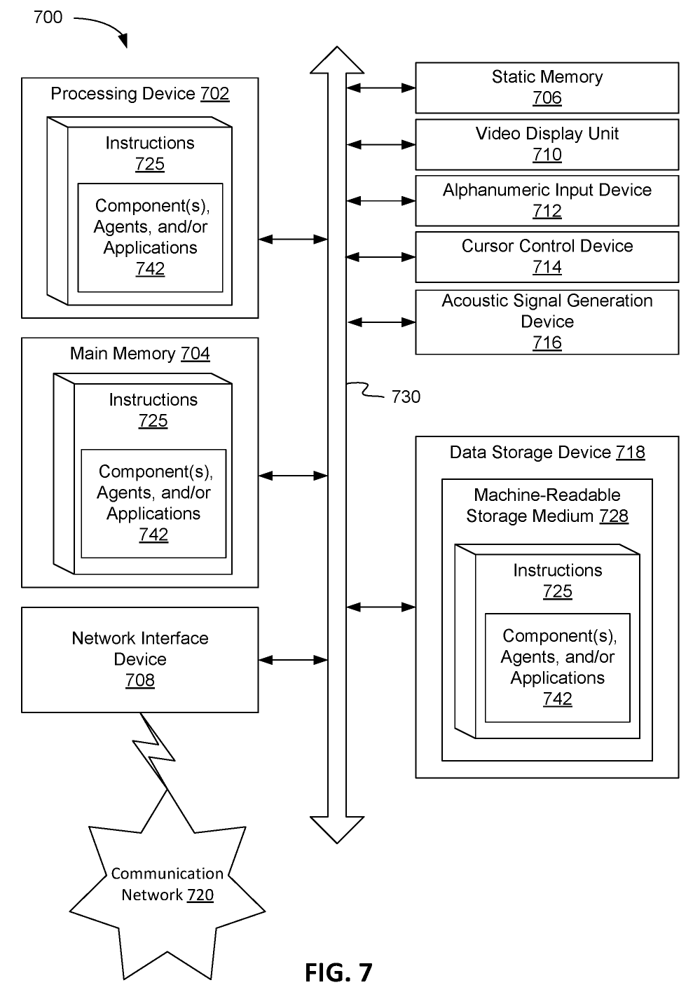

FIG. 7 is a block diagram of an example computing device that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term "computing device" shall also be taken to include any collection of computing devices that individually or jointly execute a set (or multiple sets) of instructions to perform the methods discussed herein.

The example computing device 700 may include a processing device (e.g., a general-purpose processor, a PLD, etc.) 702, a main memory 704 (e.g., synchronous dynamic random-access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also include one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a communication network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions 725 that may include instructions for one or more components/programs/applications 742 (e.g., THPD Agent 105, Device Benchmark Platform 107, PoW Challenge Platform 110, etc.) for carrying out the operations described herein, in accordance with one or more aspects of the present disclosure. Instructions 425 may also reside, completely or at least partially, within main memory 704 and/or within processing device 702 during execution thereof by computing device 700, main memory 704 and processing device 702 also constituting computer-readable media. The instructions 725 may further be transmitted or received over a communication network 720 via network interface device 708.

While computer-readable storage medium 728 is shown in an illustrative example to be a single medium, the term "computer-readable storage medium" should be taken to include a single medium or multiple media (e.g., a centralized or distributed database and/or associated caches and servers) that store the one or more sets of instructions. The term "computer-readable storage medium" shall also be taken to include any medium that is capable of storing, encoding or carrying a set of instructions for execution by the machine and that cause the machine to perform the methods described herein. The term "computer-readable storage medium" shall accordingly be taken to include, but not be limited to, solid-state memories, optical media and magnetic media.

Unless specifically stated otherwise, terms such as "receiving," "determining," "generating," "acquiring," "maintaining," "providing," "defining," "splitting," "extracting," "verifying," "indicating," or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms "first," "second," "third," "fourth," etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the embodiments of the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the embodiments of the present disclosure are not to be limited to the details given herein, but may be modified within the scope and equivalents of the appended claims.

What is claimed is:

1. A method comprising:
receiving a request to authenticate a user of a client device that is requesting access to a webpage;
determining a computational ability of the client device based on a device profile associated with the client device;
generating, by a processing device, a proof of work (PoW) challenge based on the computational ability of the client device;
acquiring an input dataset corresponding to one or more attempts by the user of the client device to solve the PoW challenge; and
generating, based on the input dataset, a report indicating whether the user of the client device is a human user or a bot user.

2. The method of claim 1, wherein the device profile associated with the client device indicates at least one of an operating system, a number of available processing cores, or graphics rendering capabilities.

3. The method of claim 1, wherein determining the computational ability of the client device further comprises:
maintaining a database comprising a plurality of mappings between a plurality of device classifications, a plurality of device profiles, and a plurality of hash rates; and
determining a classification for the client device by comparing the device profile of the client device to the database.

4. The method of claim 3, wherein determining the classification for the client device further comprises:
determining an absence of an entry in the database corresponding to the device profile of the client device;
providing, responsive to determining the absence of the entry in the database, the device profile to a near-neighbor model trained to identify a closest matching classification for the client device based on the device profile;
generating, based on the device profile and the near-neighbor model, a model output indicating the closest matching classification for the client device; and
determining a matching classification for the client device by comparing the closest matching classification for the client device to the database.

5. The method of claim 3, wherein generating the PoW challenge based on the computational ability of the client device further comprises:
determining a threat level associated with the client device based on the classification; and
defining a difficulty level for the PoW challenge by adjusting, based on the threat level, a target time associated with completing the PoW challenge.

6. The method of claim 5, wherein generating the PoW challenge based on the computational ability of the client device further comprises:
splitting the PoW challenge into a plurality of parts that are respectively associated with a plurality of sequence identifiers;
providing the plurality of parts to the client device; and
extracting, from the input dataset, a plurality of answers respectively associated with the plurality of parts responsive to providing the plurality of parts to the client device.

7. The method of claim 6, wherein splitting the PoW challenge into the plurality of parts is further based on a randomly generated number.

8. The method of claim 6, further comprising:
determining a plurality of solutions to the plurality of parts; and
verifying that each of the plurality of answers match the plurality of solutions.

9. The method of claim 8, further comprising:
determining a sequence in which the client device generated the plurality of answers; and
determining whether the sequence satisfies a sequential ordering indicated by the plurality of sequence identifiers, and either:
indicating in the report that the client device is the bot user responsive to determining that the sequence does not satisfy the sequential ordering indicated by the plurality of sequence identifiers, or
indicating in the report that the client device is the human user responsive to determining that the sequence satisfies the sequential ordering indicated by the plurality of sequence identifiers.

10. The method of claim 3, further comprising:
determining, based on the input dataset, a total execution time for the client device to solve the PoW challenge;
determining, based on the classification for the client device, an expected execution time for the client device to solve the PoW challenge; and
determining whether the expected execution time exceeds the total execution time, and either:
indicating in the report that the client device is the bot user responsive to determining that the expected execution time exceeds the total execution time, or
indicating in the report that the client device is the human user responsive to determining that the expected execution time does not exceed the total execution time.

11. A system comprising:
a memory; and
a processing device, operatively coupled to the memory, to:
receive a request to authenticate a user of a client device that is requesting access to a webpage;
determine a computational ability of the client device based on a device profile associated with the client device;
generate a proof of work (PoW) challenge based on the computational ability of the client device;
acquire an input dataset corresponding to one or more attempts by the user of the client device to solve the PoW challenge; and
generate, based on the input dataset, a report indicating whether the user of the client device is a human user or a bot user.

12. The system of claim 11, wherein the device profile associated with the client device indicates at least one of an operating system, a number of available processing cores, or graphics rendering capabilities.

13. The system of claim 11, wherein to determine the computational ability of the client device, the processing device is further to:
maintain a database comprising a plurality of mappings between a plurality of device classifications, a plurality of device profiles, and a plurality of hash rates; and
determine a classification for the client device by comparing the device profile of the client device to the database.

14. The system of claim 13, wherein to determine the classification for the client device, the processing device is further to:
determine an absence of an entry in the database corresponding to the device profile of the client device;
provide, responsive to determining the absence of the entry in the database, the device profile to a near-neighbor model trained to identify a closest matching classification for the client device based on the device profile;
generate, based on the device profile and the near-neighbor model, a model output indicating the closest matching classification for the client device; and
determine a matching classification for the client device by comparing the closest matching classification for the client device to the database.

15. The system of claim 13, wherein to generate the PoW challenge based on the computational ability of the client device, the processing device is further to:
determine a threat level associated with the client device based on the classification; and
define a difficulty level for the PoW challenge by adjusting, based on the threat level, a target time associated with completing the PoW challenge.

16. The system of claim 15, wherein to generate the PoW challenge based on the computational ability of the client device, the processing device is further to:
split the PoW challenge into a plurality of parts that are respectively associated with a plurality of sequence identifiers;
provide the plurality of parts to the client device; and
extract, from the input dataset, a plurality of answers respectively associated with the plurality of parts responsive to providing the plurality of parts to the client device.

17. The system of claim 16, wherein the processing device is further to:
determine a plurality of solutions to the plurality of parts; and
verify that each of the plurality of answers match the plurality of solutions.

18. The system of claim 16, wherein the processing device is to:
determine a sequence in which the client device generated the plurality of answers;
determine whether the sequence satisfies a sequential ordering indicated by the plurality of sequence identifiers, and either:
indicate in the report that the client device is the bot user responsive to determining that the sequence does not satisfy the sequential ordering indicated by the plurality of sequence identifiers; or
indicate in the report that the client device is the human user responsive to determining that the sequence satisfies the sequential ordering indicated by the plurality of sequence identifiers.

19. The system of claim 11, wherein the processing device is to:
determine, based on the input dataset, a total execution time for the client device to solve the PoW challenge;
determine, based on the classification for the client device, an expected execution time for the client device to solve the PoW challenge;
determine whether the expected execution time exceeds the total execution time, and either:
indicate in the report that the client device is the bot user responsive to determining that the expected execution time exceeds the total execution time; or
indicate in the report that the client device is the human user responsive to determining that the expected execution time does not exceed the total execution time.

20. A non-transitory computer-readable medium storing instructions that, when executed by a processing device, cause the processing device to:
receive a request to authenticate a user of a client device that is requesting access to a webpage;
determine a computational ability of the client device based on a device profile associated with the client device;
generate, by the processing device, a proof of work (PoW) challenge based on the computational ability of the client device;
acquire an input dataset corresponding to one or more attempts by the user of the client device to solve the PoW challenge; and
generate, based on the input dataset, a report indicating whether the user of the client device is a human user or a bot user.
